(19) United States
(12) Patent Application Publication
(10) Pub. No.: US 2026/0271932 A1
(43) Pub. Date: Sep. 17, 2026

(54) LIQUID HOMOGENEOUS AGROCHEMICAL COMPOSITION OF INSECTICIDES

(71) Applicant: ADAMA MAKHTESHIM LTD., Beer Sheva (IL)

(72) Inventors: Nadya STERN, Beer Sheva (IL); Yogev DAHAN, Tene Omarim (IL)

(73) Assignee: ADAMA MAKHTESHIM LTD., Beer Sheva (IL)

(21) Appl. No.: 19/168,691

(22) PCT Filed: Mar. 21, 2024
(86) PCT No.: PCT/IL2024/050296

§ 371 Date: Sep. 24, 2025

Related U.S. Application Data
(60) Provisional application No. 63/454,329, filed on Mar. 24, 2023.

(51) Int. Cl. A01N 43/90; A01N 25/04; A01N 25/30; A01N 47/34; A01P 7/04; A01P 21/00

(52) U.S. Cl. CPC A01N 43/90; A01N 25/04; A01N 25/30; A01N 47/34; A01P 7/04; A01P 21/00

(57) ABSTRACT

The present invention relates to storage stable, liquid homogeneous agrochemical compositions comprising novaluron, emamectin, emamectin benzoate, abamectin, spinosad or the mixtures thereof, N-alkyl pyrrolidones, amides, and surfactants and methods of use such compositions for the control of pests in a field of crop and for regulating plant growth.

### RELATED APPLICATION/S

This application claims the benefit of priority of U.S. Provisional Patent Application No. 63/454,329, filed on 24 Mar. 2023, the contents of which are incorporated herein by reference in their entirety.

### FIELD OF INVENTION

The present invention relates to storage stable, liquid homogeneous agrochemical compositions comprising novaluron, emamectin, emamectin benzoate, abamectin, spinosad or the mixtures thereof, and methods of use such compositions for the control of pests in a field of crop and for regulating plant growth.

### BACKGROUND

The major method for applying pesticides is by treating the site of treatment with a liquid composition containing the pesticide. Liquid compositions referred to two main types: emulsion concentrates and suspension concentrates. Since many of the pesticides are water insoluble or poorly soluble in water, often the pesticides are dissolved in organic solvents in the presence of surfactants to create emulsions or dispersed in a liquid medium, to form emulsion concentrates. Certain pesticides have extremely low solubility both in water and organic solvents, for example, benzoylureas like novaluron, or the group of macrolides, like emamectin benzoate, abamectin, and others. The preparation of liquid agrochemical concentrates containing the aforementioned active ingredients having low water and organic solvents solubility is very challenging.

Emulsion concentrates (also referred to as EC) are widely used liquid formulations in crop protection. Emulsion concentrates have at least the following advantages for pesticide applications, such as simple processing requirements, including easy handling and measure, simple equipment requirements, high storage stability, and high bioefficacy.

The disadvantages of the known emulsion concentrates are mostly the poor cold stability, the pronounced tendency to crystallize, the low pesticide concentration and the presence of toxic and irritative heavy organic solvents usually cause an odor problem. Furthermore, the selection of an appropriate solvent/surfactant system in emulsion concentrate containing low soluble active ingredient is an additional obstacle.

It was an object of the present invention to provide an emulsifiable concentrate which overcomes these disadvantages.

### SUMMARY

The present invention provides a liquid homogeneous agrochemical composition comprising:
a) an amount of active ingredient selected from novaluron, emamectin, emamectin benzoate, abamectin, spinosad or the mixtures thereof
b) N-alkyl pyrrolidone of formula (I):

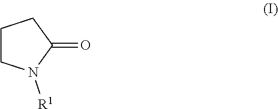

wherein R¹ is a straight or branched, saturated or unsaturated, substituted or unsubstituted alkyl group having from 4 to 10 carbon atoms;
c) an amide of formula (II):

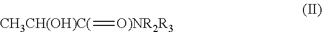

wherein R² and R³ are each independently hydrogen, C₁-C₆ alkyl, C₂-C₆ alkenyl or C₃-C₆ cycloalkyl.
d) a surfactant.

More specifically, the present invention related to a liquid homogeneous agrochemical composition comprising:
a) from 1% to 50% per weight of active ingredient selected from novaluron, emamectin, emamectin benzoate, abamectin, spinosad or the mixtures thereof, based on the total weight of the composition,
b) N-alkyl pyrrolidone of formula (I):

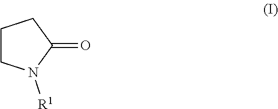

wherein R¹ is a straight or branched, saturated or unsaturated, substituted or unsubstituted alkyl group having from 4 to 10 carbon atoms;
c) an amide of formula (II):

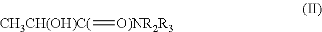

wherein R² and R³ are each independently hydrogen, C₁-C₆ alkyl, C₂-C₆ alkenyl or C₃-C₆ cycloalkyl,
d) a surfactant, selected from the group comprising EO-PO block copolymers, benzene sulfonates, alkylbenzene sulfonates, alkylnaphthalenesufonates, arylalkoxylates, vegetable oil alkoxylates and the mixtures thereof.

More specifically, the present invention related to a liquid homogeneous agrochemical composition comprising:
a) from 1% to 50% per weight of novaluron, based on the total weight of the composition,
b) N-alkyl pyrrolidone of formula (I):

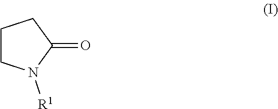

wherein R¹ is a straight or branched, saturated or unsaturated, substituted or unsubstituted alkyl group having from 4 to 10 carbon atoms;
c) an amide of formula (II):

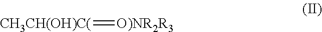

wherein R² and R³ are each independently hydrogen, C₁-C₆ alkyl, C₂-C₆ alkenyl or C₃-C₆ cycloalkyl,
d) a surfactant, selected from the group comprising EO-PO block copolymers, benzene sulfonates, alkylbenzene sulfonates, alkylnaphthalenesufonates, arylalkoxylates, vegetable oil alkoxylates and the mixtures thereof.

More specifically, the present invention related to a liquid homogeneous agrochemical composition comprising:
a) from 1% to 30% per weight of emamectin benzoate, based on the total weight of the composition,
b) N-alkyl pyrrolidone of formula (I):

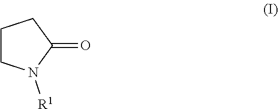

wherein R¹ is a straight or branched, saturated or unsaturated, substituted or unsubstituted alkyl group having from 4 to 10 carbon atoms;
c) an amide of formula (II):

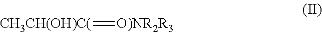

wherein R² and R³ are each independently hydrogen, C₁-C₆ alkyl, C₂-C₆ alkenyl or C₃-C₆ cycloalkyl,
d) a surfactant, selected from the group comprising EO-PO block copolymers, benzene sulfonates, alkylbenzene sulfonates, alkylnaphthalenesufonates, arylalkoxylates, vegetable oil alkoxylates and the mixtures thereof.

More specifically, the present invention related to a liquid homogeneous agrochemical composition comprising:
a) a mixture of from 1% to 50% per weight of novaluron, and from 1% to 30% per weight of emamectin benzoate, based on the total weight of the composition,
b) N-alkyl pyrrolidone of formula (I):

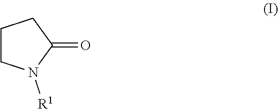

wherein R¹ is a straight or branched, saturated or unsaturated, substituted or unsubstituted alkyl group having from 4 to 10 carbon atoms;
c) an amide of formula (II):

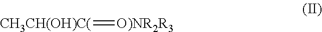

wherein R² and R³ are each independently hydrogen, C₁-C₆ alkyl, C₂-C₆ alkenyl or C₃-C₆ cycloalkyl,
d) a surfactant, selected from the group comprising EO-PO block copolymers, benzene sulfonates, alkylbenzene sulfonates, alkylnaphthalenesufonates, arylalkoxylates, vegetable oil alkoxylates and the mixtures thereof.

More specifically, the present invention related to a liquid homogeneous agrochemical composition comprising:
a) a mixture of from 1% to 50% per weight of novaluron, and from 1% to 30% per weight of abamectin, based on the total weight of the composition,
b) N-alkyl pyrrolidone of formula (I):

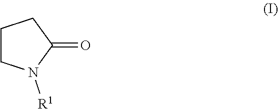

wherein R¹ is a straight or branched, saturated or unsaturated, substituted or unsubstituted alkyl group having from 4 to 10 carbon atoms;
c) an amide of formula (II):

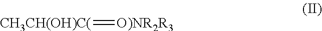

wherein R² and R³ are each independently hydrogen, C₁-C₆ alkyl, C₂-C₆ alkenyl or C₃-C₆ cycloalkyl,
d) a surfactant, selected from the group comprising EO-PO block copolymers, benzene sulfonates, alkylbenzene sulfonates, alkylnaphthalenesufonates, arylalkoxylates, vegetable oil alkoxylates and the mixtures thereof.

More specifically, the present invention related to a liquid homogeneous agrochemical composition comprising:
a) a mixture of from 1% to 50% per weight of novaluron, and from 1% to 30% per weight of spinosad, based on the total weight of the composition,
b) N-alkyl pyrrolidone of formula (I):

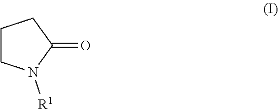

wherein R¹ is a straight or branched, saturated or unsaturated, substituted or unsubstituted alkyl group having from 4 to 10 carbon atoms;
c) an amide of formula (II):

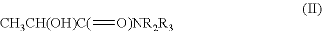

wherein R² and R³ are each independently hydrogen, C₁-C₆ alkyl, C₂-C₆ alkenyl or C₃-C₆ cycloalkyl,
d) a surfactant, selected from the group comprising EO-PO block copolymers, benzene sulfonates, alkylbenzene sulfonates, alkylnaphthalenesufonates, arylalkoxylates, vegetable oil alkoxylates and the mixtures thereof.

The present invention further provides a method of controlling pest comprising applying to a locus where control of said pest is desired an effective amount of the composition disclosed herein.

Furthermore, the present invention is related to a method for the protection of plant propagation material from the attack by a pest such as an insect, comprising treating the propagation material or the site where the propagation material is to be planted with an effective amount of the composition disclosed herein.

In addition, the present invention provides a method for regulating plant growth comprising applying to the plant, a locus of the plant and/or propagation material of the plant an effective amount of the compositions disclosed herein, so as to thereby regulate plant growth.

### DESCRIPTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and in the claims and its conjugations are used in its non-limiting sense to mean that items following the word are included, but items not specifically mentioned are not excluded.

As used herein, the term “and/or” includes any and all combinations of one or more of the associated listed items. Expressions such as “at least one of,” when preceding a list of elements, modify the entire list of elements and do not modify the individual elements of the list.

As used herein, the term “about” when used in connection with a numerical value includes +10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “pest” includes, but is not limited to, unwanted insect and/or unwanted nematode, and weed.

As used herein, the term “pesticide” broadly refers to an agent that can be used to prevent, control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, U K, 2003-04), the contents of each of which are incorporated herein by reference in their entirety.

As used herein, the term “locus” includes not only areas where the pest may already be developed, but also areas where pests have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. spores, corms, bulbs, rhizomes, sprouts basal shoots, stolons, and buds and other parts of plants, including seedlings and young plants, which are to be transplanted after germination or after emergence from soil.

The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts, basal shoots, stolons, and buds and other parts of plants, including seedlings and young plants, which are to be transplanted after germination, rooting or after emergence from soil or any other kind of substrate, be it artificial or natural.

As used herein the term “propagation material” is to be understood to denote all the generative parts of the plant such as seeds and spores, vegetative structures such as bulbs, corms, tubers, rhizomes, roots stems, basal shoots, stolons and buds.

The composition of invention:

The present invention provides a liquid homogeneous agrochemical composition comprising:
a) an amount of active ingredient selected from novaluron, emamectin, emamectin benzoate, abamectin, spinosad or the mixtures thereof
b) N-alkyl pyrrolidone of formula (I):

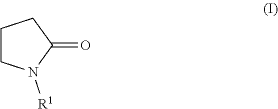

wherein R¹ is a straight or branched, saturated or unsaturated, substituted or unsubstituted alkyl group having from 4 to 10 carbon atoms;
c) an amide of formula (II):

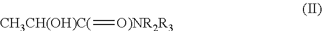

wherein R² and R³ are each independently hydrogen, C₁-C₆ alkyl, C₂-C₆ alkenyl or C₃-C₆ cycloalkyl.
d) a surfactant.

In an embodiment, the N-alkyl pyrrolidone of formula (I) is selected from the group comprising N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone and the mixtures thereof.

In another embodiment, the N-alkyl pyrrolidone of formula (I) is selected from N-butyl-2-pyrrolidone and/or N-octyl-2-pyrrolidone.

In an embodiment, the amide of formula (II) is selected from N,N-dimethyllactamide, N,N-diethyllactamide, and N,N-methylethyl lactamide and the mixtures thereof.

In another embodiment, the amide of formula (II) is N,N-dimethyllactamide.

In an embodiment, the surfactant d) is selected from the group comprising EO-PO block copolymers, benzene sulfonates, alkylbenzene sulfonates, alkylnaphthalenesufonates, arylalkoxylates, vegetable oil alkoxylates and the mixtures thereof.

In an embodiment, the EO-PO block copolymers comprising polyoxyethylene-polyoxypropylene-block copolymers, or alkyl ethers thereof, such as C1-C10 alkyl ethers thereof. Preferably, the block copolymer is nonionic. Particularly preferred is polyoxyethylene-polyoxypropylene block copolymer butyl ether, commercially available, for example, as Atlas G-5002 (Croda).

In an embodiment, arylalkoxylates surfactants are styrylphenol polyalkoxylates in which, a phenoxy radical carries 1, 2 or 3 styryl moieties and a polyalkylene oxide moiety, which is typically a polyethylene oxide (PEO), polypropylene oxide (PPO), or a poly(ethylenoxide-propylenoxide) (EO/PO) moiety. The polyalkylene oxide moiety typically comprises from about 5 to 100 alkylene oxide groups. Preferred surfactants of this group are ethoxylated tri (styryl) phenols group; commercially available, for example, as Soprophor TS/16, or Soprophor TS/54 (Solvay).

In an embodiment, the benzene sulfonates and alkylbenzene sulfonates in the composition disclosed herein have the following general formula III:

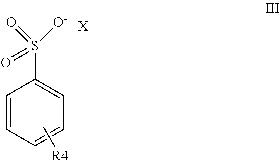

In formula III, the R₄ group can be in the ortho-, meta-, or para-position and is hydrogen or a linear or branched C3-C14 alkyl group. For example, the R₄ group can be a linear dodecyl (C12)alkyl chain or a branched C12 alkyl chain. The R₄ group can be attached to the benzene ring of the alkylbenzene sulfonate surfactant molecule at any position along the R₄ group. In Formula III, suitable X⁺ cations include isopropyl ammonium, dimethyl ammonium, triethyl ammonium, monoethanol ammonium, diethanol ammonium, triethanol ammonium, dimethylethanol ammonium, diethyleneglycol ammonium, triisopropanol ammonium, tetramethyl ammonium, tetraethyl ammonium, choline, calcium, magnesium, potassium and sodium.

As used herein, the alkylbenzene sulfonate surfactant can include a mixture of linear and/or branched R₄ groups with different lengths (e.g., C3-C14) attached to the alkylbenzene sulfonate surfactant molecules at different positions along the R₄ group.

The alkyl naphthalene sulfonates to be used in the compositions disclosed herein preferably have alkyl groups with 1-10 carbon atoms, such as methyl, isopropyl, n-butyl, sec-butyl, and nonyl. Especially preferred products are sodium butyl naphthalene sulfonate and sodium nonyl naphthalene sulfonate. Examples of commercial alkyl naphthalene sulfonates are Morwet® B and Morwet IP.

Vegetable oil alkoxylates to be used in the compositions disclosed herein are derived from suitable vegetable oils which known to be used in agrochemical compositions and can be obtained from plants. Examples that may be mentioned include sunflower oil, rapeseed oil, olive oil, castor oil, colza oil, maize seed oil, cottonseed oil and soya-bean oil.

The aforementioned vegetable oil alkoxylates contain polyalkylene oxide moiety, which is typically a polyethylene oxide (PEO), polypropylene oxide (PPO), or a poly(ethylenoxide-propylenoxide) (EO/PO) moiety. The polyalkylene oxide moiety typically comprises from about 5 to 100 alkylene oxide groups.

In an embodiment, the amount of an active ingredient a) in the compositions disclosed herein is from 1% to 50% per weight, based on the total weight of the composition.

In yet another embodiment, the amount of an active ingredient a) in the compositions disclosed herein is from 1% to 30% per weight, based on the total weight of the composition.

In yet another embodiment, the amount of an active ingredient a) in the compositions disclosed herein is from 1% to 25% per weight, based on the total weight of the composition.

In yet another embodiment, the amount of an active ingredient a) in the compositions disclosed herein is from 1% to 10% per weight, based on the total weight of the composition.

In yet another embodiment, the amount of an active ingredient a) in the compositions disclosed herein is from 1% to 5% per weight, based on the total weight of the composition.

In some embodiment, the weight ratio between the N-alkyl pyrrolidone of formula (I) and amide of formula (II) is from 4:1 to 1:1.

In an embodiment, the weight ratio between the N-alkyl pyrrolidone of formula (I) and amide of formula (II) is from 3.5:1 to 1:1.
weight ratio between the N-alkyl pyrrolidone of formula (I) and amide of formula (II) is from 3:1 to 1:1.
weight ratio between the N-alkyl pyrrolidone of formula (I) and amide of formula (II) is from 2:1 to 1:1.

In an embodiment, the weight ratio between N-alkyl-pyrrolidone of formula (I) and active ingredient a) in the compositions disclosed herein is from 5:1 to 1:1.

In an embodiment, the weight ratio between N-alkyl-pyrrolidone of formula (I) and active ingredient a) in the compositions disclosed herein is from 4:1 to 1:1.

In an embodiment, the weight ratio between N-alkyl-pyrrolidone of formula (I) and active ingredient a) in the compositions disclosed herein is from 3:1 to 1:1.

In an embodiment, the weight ratio between N-alkyl-pyrrolidone of formula (I) and active ingredient a) in the compositions disclosed herein is from 2:1 to 1:1.

In an embodiment, the weight ratio between amide of formula (II) and active ingredient a) in the compositions disclosed herein is from 3:1 to 1:1.

In an embodiment, the weight ratio between amide of formula (II) and active ingredient a) in the compositions disclosed herein is from 2:1 to 1:1.

In an embodiment, the liquid homogeneous agrochemical composition disclosed herein comprises a) from 1% to 40% per weight of novaluron as an active ingredient.

In an embodiment, the liquid homogeneous agrochemical composition disclosed herein comprises a) from 1% to 35% per weight of novaluron as an active ingredient.

In an embodiment, the liquid homogeneous agrochemical composition disclosed herein comprises a) from 1% to 30% per weight of novaluron as an active ingredient.

In an embodiment, the liquid homogeneous agrochemical composition disclosed herein comprises a) from 1% to 25% per weight of novaluron as an active ingredient.

In an embodiment, the liquid homogeneous agrochemical composition disclosed herein comprises a) from 1% to 20% per weight of novaluron as an active ingredient.

In an embodiment, the liquid homogeneous agrochemical composition disclosed herein comprises a) from 1% to 10% per weight of novaluron as an active ingredient.

In an embodiment, the liquid homogeneous agrochemical composition disclosed herein comprises a) from 1% to 5% per weight of novaluron as an active ingredient.

In an embodiment, the liquid homogeneous agrochemical composition disclosed herein comprises a) from 1% to 30% per weight of emamectin benzoate as an active ingredient.

In an embodiment, the liquid homogeneous agrochemical composition disclosed herein comprises a) from 1% to 25% per weight of emamectin benzoate as an active ingredient.

In an embodiment, the liquid homogeneous agrochemical composition disclosed herein comprises a) from 1% to 20% per weight of emamectin benzoate as an active ingredient.

In an embodiment, the liquid homogeneous agrochemical composition disclosed herein comprises a) from 1% to 10% per weight of emamectin benzoate as an active ingredient.

In an embodiment, the liquid homogeneous agrochemical composition disclosed herein comprises a) from 1% to 5% per weight of emamectin benzoate as an active ingredient.

In an embodiment, the liquid homogeneous agrochemical composition disclosed herein comprises novaluron as an active ingredient a) and the weight ratio between an amide of formula (II) and novaluron is from 3:1 to 1:1.

In an embodiment, the liquid homogeneous agrochemical composition disclosed herein comprises novaluron as an active ingredient a) and the weight ratio between an amide of formula (II) and novaluron is from 2:1 to 1:1.

In an embodiment, the liquid homogeneous agrochemical composition disclosed herein comprises novaluron as an active ingredient a) and the weight ratio between N-alkyl-pyrrolidone of formula (I) and novaluron is from 5:1 to 1:1.

In an embodiment, the liquid homogeneous agrochemical composition disclosed herein comprises novaluron as an active ingredient a) and the weight ratio between N-alkyl-pyrrolidone of formula (I) and novaluron is from 4:1 to 1:1.

In an embodiment, the liquid homogeneous agrochemical composition disclosed herein comprises novaluron as an active ingredient a) and the weight ratio between N-alkyl-pyrrolidone of formula (I) and novaluron is from 3:1 to 1:1.

In an embodiment, the liquid homogeneous agrochemical composition disclosed herein comprises novaluron as an active ingredient a) and the weight ratio between N-alkyl-pyrrolidone of formula (I) and novaluron is from 2:1 to 1:1.

In an embodiment, the liquid homogeneous agrochemical composition disclosed herein comprises novaluron as an active ingredient a) and the weight ratio between an amide of formula (II) and emamectin benzoate is from 3:1 to 1:1.

In an embodiment, the liquid homogeneous agrochemical composition disclosed herein comprises novaluron as an active ingredient a) and the weight ratio between an amide of formula (II) and emamectin benzoate is from 2:1 to 1:1.

In an embodiment, the liquid homogeneous agrochemical composition disclosed herein comprises novaluron as an active ingredient a) and the weight ratio between N-alkyl-pyrrolidone of formula (I) and emamectin benzoate is from 5:1 to 1:1.

In an embodiment, the liquid homogeneous agrochemical composition disclosed herein comprises novaluron as an active ingredient a) and the weight ratio between N-alkyl-pyrrolidone of formula (I) and emamectin benzoate is from 4:1 to 1:1.

In an embodiment, the liquid homogeneous agrochemical composition disclosed herein comprises novaluron as an active ingredient a) and the weight ratio between N-alkyl-pyrrolidone of formula (I) and emamectin benzoate is from 3:1 to 1:1.

In an embodiment, the liquid homogeneous agrochemical composition disclosed herein comprises novaluron as an active ingredient a) and the weight ratio between N-alkyl-pyrrolidone of formula (I) and emamectin benzoate is from 2:1 to 1:1.

In an embodiment, the liquid homogeneous agrochemical composition disclosed herein comprises an active ingredient a), which is a mixture of from 1% to 50% per weight of novaluron and from 1% to 30% per weight of emamectin benzoate, based on the total weight of composition.

In an embodiment, the liquid homogeneous agrochemical composition disclosed herein comprises an active ingredient a), which is a mixture of from 1% to 30% per weight of novaluron and from 1% to 20% per weight of emamectin benzoate, based on the total weight of composition.

In an embodiment, the liquid homogeneous agrochemical composition disclosed herein comprises an active ingredient a), which is a mixture of from 1% to 20% per weight of novaluron and from 1% to 20% per weight of emamectin benzoate, based on the total weight of composition.

In an embodiment, the liquid homogeneous agrochemical composition disclosed herein comprises an active ingredient a), which is a mixture of from 1% to 50% per weight of novaluron and from 1% to 30% per weight of abamectin, based on the total weight of composition.

In an embodiment, the liquid homogeneous agrochemical composition disclosed herein comprises an active ingredient a), which is a mixture of from 1% to 30% per weight of novaluron and from 1% to 20% per weight of abamectin, based on the total weight of composition.

In an embodiment, the liquid homogeneous agrochemical composition disclosed herein comprises an active ingredient a), which is a mixture of from 1% to 20% per weight of novaluron and from 1% to 20% per weight of abamectin, based on the total weight of composition.

In an embodiment, the liquid homogeneous agrochemical composition disclosed herein comprises an active ingredient a), which is a mixture of from 1% to 50% per weight of novaluron and from 1% to 30% per weight of spinosad, based on the total weight of composition.

In an embodiment, the liquid homogeneous agrochemical composition disclosed herein comprises an active ingredient a), which is a mixture of from 1% to 30% per weight of novaluron and from 1% to 20% per weight of spinosad, based on the total weight of composition.

In an embodiment, the liquid homogeneous agrochemical composition disclosed herein comprises an active ingredient a), which is a mixture of from 1% to 20% per weight of novaluron and from 1% to 20% per weight of spinosad, based on the total weight of composition.

Another aspect of the present invention provides a method of controlling pest comprising applying to a locus where control of said pest is desired an effective amount of the compositions disclosed herein. The present invention further provides a method for the protection of plant propagation material from the attack by a pest such as an insect, comprising treating the propagation material or the site where the propagation material is to be planted with an effective amount of the compositions disclosed herein. In further embodiments, the present invention provides a method for regulating plant growth comprising applying to the plant, a locus of the plant and/or propagation material of the plant an effective amount of the compositions disclosed herein, so as to thereby regulate plant growth.

In an embodiment, said pest is referred to an insect pest selected from Lepidoptera, Coleoptera, Isoptera, Hemiptera, Orthoptera, Thysanoptera and Diptera species.

In an embodiment, the target pest belongs to Acarina pest (e.g., mites).

In particular, Coleoptera, such as Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

Diptera, such as Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cocliliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (grass fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies) and Tipula spp. (crane flies).

Hemiptera, such as Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

Lepidoptera, such as Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera fugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), chistocerca gregaria, Scudderia furcata (forktailed bush katydid) and Valanga nigricorni.

Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

Acarina, such as Acarus siro, Aceria spp., Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus spp., Eurytetranychus spp., Eriophyes spp., Hyalomma spp., Ixodes spp., Nalepella spp., Olygonychus spp., Ornithodoros spp., Panonychus spp., Phyllocoptruta oleivora, Phytonemus spp., Polyphagotarsonemus latus, Psoroptes spp., Rhipicephalus spp., Rhizoglyphus spp., Sarcoptes spp., Tarsonemus spp., Tetranychus spp, and Vasates spp.

In certain embodiments, the locus treated by the method disclosed herein above is a field of crop. The term “crop” (or “plant”) as used herein refers to whole plants, plant organs (e.g., leaves, stems, twigs, roots, trunks, limbs, shoots, fruits, etc.), plant cells, or plant seeds. Non-limiting examples of crops are oilseed rape (e.g. canola), cotton, rice, banana, potato (including sweet potato), coffee, sugar cane, citrus, beans, sunflower, corn, soybean, wheat, barley, oats, chickpeas, fruit trees, nut trees (e.g. almonds), lentils, grain sorghum, alfalfa, brassicas, fruiting vegetables (e.g. tomatoes, pepper, chili, eggplant, cucumber, squash etc.), tea, bulb vegetables (e.g. onion, leek etc.), grapes, pome fruit (e.g. apples, pears etc.), and stone fruit (e.g. pears, plums etc.)

In an embodiment, the crop is selected from sugarcane, Solanaceae plant, maize, rice, corn, cotton, soybean, Brassica plant, citrus, pome fruits, and tree nuts.

### EXPERIMENTAL PART

Examples provided below establish a more complete understanding of the present subject matter. The following examples illustrate the exemplary modes of making and practicing the present invention. However, the scope of the present invention is not limited to specific embodiments disclosed in these Examples, which are for purposes of illustration only. Other examples will be apparently constructed by one skilled in the art from consideration of the specification embodiments and examples.

### Example 1. Preparation of Exemplified Compositions

All homogeneous compositions represented below were prepared according to the following process:
1. Active ingredients were mixed with the formulation solvents and the resulting mixture was agitated at 65-70° C. until all solid material was dissolved and clear solution obtained.
2. The resulting clear solution was cooled to room temperature and then all required amounts of surfactants were added to the clear solution; then the resulting mixture was sheared to obtain a solution.
3. The resulting solution was filtered to obtain final homogeneous composition.

TABLE 1
Inventive compositions A, B, C, D.

| | Composition | Composition | Composition | Composition |
|---|---|---|---|---|
| | A % w/w | B % w/w | C % w/w | D % w/w |
| Ingredient | amount | amount | amount | amount |
| Emamectin | 13.7 | 13.7 | 13.5 | 13.5 |
| benzoate | | | | |
| (tech) | | | | |
| Novaluron | 17.5 | 17.5 | 17.2 | 17.2 |
| (tech) | | | | |
| N-octyl | 43.1 | 30.8 | 0 | 0 |
| pyrrolidone | | | | |
| Agnique | 18.5 | 30.8 | 11.9 | 29.7 |
| AMD 3L | | | | |
| Tergitol XD | 3.5 | 2.4 | 0 | 0 |
| Ninate 70B | 1.9 | 2.4 | 0 | 0 |
| Castor oil 20 | 1.8 | 2.4 | 0 | 0 |
| N-butyl | 0 | 0 | 47.5 | 29.7 |
| pyrrolidone | | | | |
| Rhodacal | 0 | 0 | 3.3 | 3.3 |
| 60/BE | | | | |
| Soprophor | 0 | 0 | 3.3 | 3.3 |
| TS/16 | | | | |
| Ethylan | 0 | 0 | 3.3 | 3.3 |
| NS 500 | | | | |

TABLE 2
Comparative compositions E, F, J, H.

| | Composition | Composition | Composition | Composition |
|---|---|---|---|---|
| | E % w/w | F % w/w | J % w/w | H % w/w |
| Ingredient | amount | amount | amount | amount |
| Emamectin | 13.1 | 13.1 | 13.1 | 13.1 |
| benzoate | | | | |
| (tech) | | | | |
| Novaluron | 16.8 | 16.8 | 16.8 | 16.8 |
| (tech) | | | | |
| N-octyl | 0 | 0 | 0 | 32.3 |
| pyrrolidone | | | | |
| Agnique | 67.4 | 0 | 13.5 | 12.6 |
| AMD 3L | | | | |
| Soprophor | 1.8 | 1.8 | 1.8 | 1.8 |
| 3D 33 | | | | |
| Rhodiasolv | 0 | 67.4 | 53.6 | 22.2 |
| PolarClean | | | | |
| N-butyl | 0 | 0 | 0.38 | 0 |
| pyrrolidone | | | | |
| Ethylan | 0.9 | 0.9 | 0.9 | 0.9 |
| NS 500 | | | | |

TABLE 3
Physical stability data for Compositions A-H.

| Composition | Storage stability | Storage stability | Storage | Storage stability |
|---|---|---|---|---|
| code | RT ° C. | 0° C. | stability −10° C. | 54° C. |
| A | No crystals or | No crystals or | No crystals or | No crystals or |
| | sedimentation | sedimentation | sedimentation | sedimentation |
| B | No crystals or | No crystals or | No crystals or | No crystals or |
| | sedimentation | sedimentation | sedimentation | sedimentation |
| C | No crystals or | No crystals or | No crystals or | No crystals or |
| | sedimentation | sedimentation | sedimentation | sedimentation |
| D | No crystals or | No crystals or | No crystals or | No crystals or |
| | sedimentation | sedimentation | sedimentation | sedimentation |
| E | crystallization | crystallization | crystallization | No crystals or |
| | | | | sedimentation |
| F | crystallization | crystallization | crystallization | No crystals or |
| | | | | sedimentation |
| J | crystallization | crystallization | crystallization | No crystals or |
| | | | | sedimentation |
| H | crystallization | crystallization | crystallization | No crystals or |
| | | | | sedimentation |

What is claimed is:

1. A liquid homogeneous agrochemical composition comprising:
a) an amount of active ingredient selected from novaluron, emamectin, emamectin benzoate, abamectin, spinosad or the mixtures thereof;
b) N-alkyl pyrrolidone of formula (I): 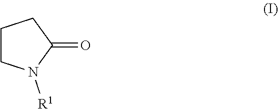
wherein R¹ is a straight or branched, saturated or unsaturated, substituted or unsubstituted alkyl group having from 4 to 10 carbon atoms;
c) an amide of formula (II): 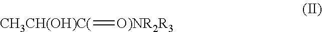
wherein R² and R³ are each independently hydrogen, C₁-C₆ alkyl, C₂-C₆ alkenyl or C₃-C₆ cycloalkyl;
d) a surfactant.

2. The liquid homogeneous agrochemical composition according to claim 1, wherein the alkyl pyrrolidone of formula (I) is selected from the group comprising N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone and the mixtures thereof.

3. The liquid homogeneous agrochemical composition according to any of claims 1-2 wherein the amide of formula (II) is selected from N,N-dimethyllactamide, N,N-diethyllactamide, and N,N-methylethyl lactamide and the mixtures thereof.

4. The liquid homogeneous agrochemical composition according to any of claims 1-3, wherein the surfactant is selected from the group comprising EO-PO block copolymers, benzene sulfonates, alkylbenzene sulfonates, alkylnaphthalenesufonates, arylalkoxylates, vegetable oil alkoxylates and the mixtures thereof.

5. The liquid homogeneous agrochemical composition according to any one of claims 1-4, wherein the amount of an active ingredient a) is from 1% to 50% per weight, based on the total weight of the composition.

6. The liquid homogeneous agrochemical composition according to any one of claims 1-5, wherein, the weight ratio between the N-alkyl pyrrolidone of formula (I) and amide of formula (II) is from 4:1 to 1:1.

7. The liquid homogeneous agrochemical composition according to any one of claims 1-6, wherein, the weight ratio between N-alkyl-pyrrolidone of formula (I) and active ingredient a) is from 5:1 to 1:1.

8. The liquid homogeneous agrochemical composition according to any one of claims 1-7, wherein, the weight ratio between amide of formula (II) and active ingredient a) is from 3:1 to 1:1.

9. The liquid homogeneous agrochemical composition according to any of claims 1-8, wherein, active ingredient a) is novaluron and the weight ratio between an amide of formula (II) and novaluron is from 3:1 to 1:1.

10. The liquid homogeneous agrochemical composition according to any of claims 1-9, wherein, active ingredient a) is novaluron and the weight ratio between N-alkyl-pyrrolidone of formula (I) and novaluron is from 5:1 to 1:1.

11. The liquid homogeneous agrochemical composition according to any of claims 1-8, wherein the active ingredient a) is a mixture of novaluron and emamectin benzoate.

12. The liquid homogeneous agrochemical composition according to claim 11, wherein the amount of novaluron is from 1% to 50% per weight, and the amount of emamectin benzoate is from 1% to 30% per weight, based on the total weight of composition.

13. The liquid homogeneous agrochemical composition according to any of claims 1-8, wherein the active ingredient a) is a mixture of novaluron and abamectin.

14. The liquid homogeneous agrochemical composition according to claim 13, wherein the amount of novaluron is from 1% to 50% per weight, and the amount of abamectin is from 1% to 30% per weight, based on the total weight of composition.

15. The liquid homogeneous agrochemical composition according to any of claims 1-8, wherein the active ingredient a) is a mixture of novaluron and spinosad.

16. The liquid homogeneous agrochemical composition according to claim 15, wherein the amount of novaluron is from 1% to 50% per weight, and the amount of spinosad is from 1% to 30% per weight, based on the total weight of composition.

17. A method of controlling pest comprising applying to a locus where control of said pest is desired an effective amount of the composition according to any one of claims 1-16.

18. The method of claim 17, wherein said pest is selected from Lepidoptera, Coleoptera, Isoptera and Diptera species.

19. The method according to any of claims 17-18, wherein said locus is a field of crop.

20. The method according to claim 19, wherein said crop is selected from sugarcane, Solanaceae plant, maize, rice, corn, cotton, soybean, Brassica plant, citrus, pome fruits, tree nuts.

21. A method for the protection of plant propagation material from the attack by a pest such as an insect, comprising treating the propagation material or the site where the propagation material is to be planted with an effective amount of the composition according to any one of claims 1-16.

22. A method for regulating plant growth comprising applying to the plant, a locus of the plant and/or propagation material of the plant an effective amount of the composition according to any of claims 1-16.
